(19) United States
(12) Patent Application Publication
(10) Pub. No.: US 2025/0091140 A1
(43) Pub. Date: Mar. 20, 2025

(54) Metal Sheet Screw Position Template

(71) Applicant: Virginia Garcia-Alvarez, Dillon, SC (US)

(72) Inventor: Virginia Garcia-Alvarez, Dillon, SC (US)

(21) Appl. No.: 18/470,545

(22) Filed: Sep. 20, 2023

(51) Int. Cl. B23B 47/28

(52) U.S. Cl. CPC B23B 47/287

(57) ABSTRACT

The present invention generally relates to a metal sheet screw position template designed primarily for use with metal roofing and carports. Metal sheets are generally installed on a structure with screws. Location of those screws is important for proper fastening and the overall symmetrical appearance of installation. The invention provides a template that is placed on a standard metal sheet to locate the screw positions in a fast and symmetrical manner so as to speed the process of installation, while ensuring a very symmetrical screw pattern for the entire roof or carport.

The present invention generally relates to systems and methods of screw templates and, more particularly, to a template for locating drill locations in metal sheets for proper screw fastening.

### BACKGROUND OF THE INVENTION

Metal sheets, often called multi-rib or agricultural panels, are used for roofing and siding in many building or upgrade applications. Multi-rib roofing, for example, is generally manufactured to specific lengths for each job, where each sheet is cut to the entire length of the roof on each side with each sheet 38.5 inches wide. This provides a full 3-foot-wide sheet with one overlapping rib. A typical metal roofing sheet has 5 large ribs and 8 small ribs for added strength. One of the large ribs is used in each sheet for overlap with the next contiguous sheet to the left or right. For purposes of this application, the inventor refers to these as metal roofing sheets or just metal sheets.

These metal sheets are generally fastened with a multitude of metal screws. In most cases, each sheet is placed on a roof joist made of wood or metal and then a series of screws is installed passing through the sheet into the joist to hold the sheet in place. In some cases, the same type of metal sheeting is installed vertically as siding. In all cases, the installer must make a series of measurements to ensure that each sheet is properly fastened to the joists or studs underneath.

Most screws are installed beginning at the bottom of the roof and placed by measuring the distance from the edge of the roof overhang to the first wall stud underneath. Generally, four screws are applied side-to-side (horizontally) for each metal sheet. Then the installer moves upwards (vertically) three feet by measurement and installs four more screws left to right. This process is repeated every three feet vertically for the entire metal sheet until he reaches the top of the metal sheet at the roof's crest.

The multitude of measurements required in this process creates a number of problems. First, it takes a great deal of time to measure for each screw placement. Second, continual measuring is often inaccurate. Third, some installers simply cut corners and resort to eyeball measurements, leading to unsightly and potentially unsafe installation from uneven screw patterns.

What is needed is a system and method of locating the proper screw positions for a metal sheet to provide consistent and accurate screw placement to fasten each sheet.

An object of the present invention is to provide a system and method of locating the proper screw positions for a metal sheet to provide consistent and accurate screw placement.

What is also needed is a system and method of locating the proper screw positions that would allow an installer to speed up the installation process by pre-drilling or pre-locating all screw positions on a metal sheet.

An object of the present invention is to provide a system and method of locating the proper screw positions for a metal sheet to provide consistent and accurate screw placement.

What is also needed is a system and method of locating the proper screw positions that would allow an installer to further speed up the installation process by pre-drilling or pre-locating the screw positions on an entire stack of metal sheets.

Another object of the present invention is to provide a system and method of locating the proper screw positions that would allow an installer to further speed up the installation process by pre-drilling or pre-locating the screw positions on an entire stack of metal sheets.

### SUMMARY OF THE INVENTION

The present invention accomplishes the foregoing objects by providing a metal sheet screw position template. A preferred embodiment of the invention is a template approximately four feet long and six inches wide that includes four divots on its underside to receive the four large ribs in a standard width, multi-rib metal sheet. The preferred embodiment also includes a series of magnets on its underside to firmly attach itself to the metal sheet. When placed onto a standard metal sheet, the four divots align with the four ribs of the metal sheet and the magnets firmly attach the invention to the metal sheet.

Once in place on the metal sheet, the invention includes a series of 4 holes, each spaced 8 inches apart and placed in the proper location to provide for proper screw placement of 4 screws horizontally across the metal sheet. Each of the 4 holes is optimally placed to allow for at least 2 to pass through into the joist or stud underneath the metal sheet, while the remaining 2 provide additional attachment to hold the sheet down and in place without buckling the metal.

The invention further provides an arrow to visually indicate proper left to right placement. A preferred embodiment of the invention includes a sight hole to provide for location of the first screw placement. The installer typically measures from the edge of the overhang the distance to the wall and then marks this position on the first rib at the beginning of installation. Once the invention is placed on the first sheet, the installer places the invention carefully over the marked position of the first screw, thereby providing proper alignment of the entire invention for the remaining screws. Once a first sheet has been installed, the invention can be moved to the next sheet to begin the same process for each sheet.

In a preferred embodiment of the invention, the template saves approximately ten to twenty percent of the time normally required to install an entire roof by speeding up the process of screw hole location for single metal sheets, while simultaneously providing symmetrical and consistent screw placement for the entire roof.

In another preferred embodiment of the invention, the template saves approximately fifty percent of the time normally required to install an entire roof by speeding up the process of screw hole location for an entire stack of metal sheets, while simultaneously providing symmetrical and consistent screw placement for the entire roof. In this embodiment, the template is used for a stack of metal sheets, where the installer pre-drills all the screw holes at once all the way through the stack.

The present invention further accomplishes the foregoing objects by providing a metal sheet screw position template, comprising: a horizontal alignment hole to indicate a proper horizontal screw position; a vertical alignment hole to indicate a proper vertical screw position; and a divot designed to receive a metal sheet rib.

This embodiment of the system may further comprise a magnet for firmly attaching a metal sheet to said metal sheet screw position template.

This embodiment of the system may further comprise a handle for carrying said metal sheet screw position template.

This embodiment of the system may further comprise a measurement tape extending perpendicularly from said metal sheet screw position template to indicate a next placement of said metal sheet screw position template.

The present invention further accomplishes the foregoing objects by providing a method of using a metal sheet screw position template, comprising the steps of: providing a metal sheet for installation upon a structure; measuring an overhang on the roof of said structure; marking the distance of said overhang on said metal sheet; placing a metal sheet screw position template on said metal sheet, said metal sheet screw position template comprising: a horizontal alignment hole to indicate a proper horizontal screw position; and a vertical alignment hole to indicate a proper vertical screw position; then aligning said vertical alignment bole with said distance of said overhang; marking the location of at least one said proper horizontal screw position; and drilling a hole in said metal sheet at the location of said at least one said proper horizontal screw position.

This embodiment of the system may further comprise a metal sheet screw position template further comprising a divot designed to receive a metal sheet rib.

This embodiment of the system may further comprise a metal sheet screw position template further comprising a magnet for firmly attaching to said metal sheet.

This embodiment of the system may further comprise a metal sheet screw position template further comprising a handle for carrying.

This embodiment of the system may further comprise a metal sheet screw position template further comprising a measurement tape extending perpendicularly therefrom.

The present invention further accomplishes the foregoing objects by providing a method of using a metal sheet screw position template, comprising the steps of: providing a stack of metal sheets for installation upon a structure; measuring an overhang on the roof of said structure; marking the distance of said overhang on a first metal sheet; placing a metal sheet screw position template on said first metal sheet, said metal sheet screw position template comprising: a horizontal alignment hole to indicate a proper horizontal screw position; and a vertical alignment hole to indicate a proper vertical screw position; then aligning said vertical alignment hole with said distance of said overhang; marking the location of at least one said proper horizontal screw position; and drilling a hole in two or more metal sheets of said stack of metal sheets at the location of said at least one said proper horizontal screw position.

This embodiment of the system may further comprise a metal sheet screw position template further comprising a divot designed to receive a metal sheet rib.

This embodiment of the system may further comprise a metal sheet screw position template further comprising a magnet for firmly attaching to said metal sheet.

This embodiment of the system may further comprise a metal sheet screw position template further comprising a handle for carrying.

This embodiment of the system may further comprise a metal sheet screw position template further comprising a measurement tape extending perpendicularly therefrom.

### DESCRIPTION OF THE DRAWINGS

The invention will be more readily understood with reference to the following specification in conjunction with the drawings herein:

FIG. 1 is a top perspective view of a metal sheet screw position template according to a preferred embodiment of the invention.

FIG. 2 is bottom perspective view of a metal sheet screw position template according to a preferred embodiment of the invention.

FIG. 3 is a perspective of a metal sheet screw position template in use on a standard metal roof according to a preferred embodiment of the invention.

FIG. 4 is a perspective of a metal sheet screw position template in use on a standard metal roof according to a preferred embodiment of the invention.

FIG. 5 is a perspective of a metal sheet screw position template in use on a stack of standard metal roof sheets according to a preferred embodiment of the invention.

### DESCRIPTION OF THE PREFERRED EMBODIMENTS

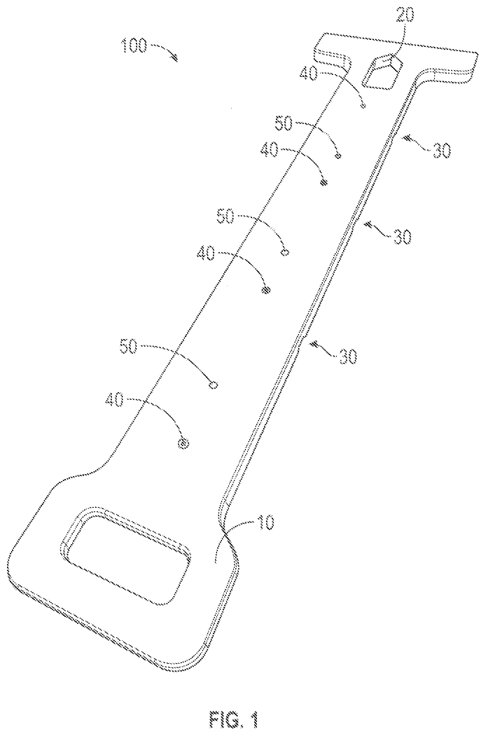

Referring now to FIG. 1, a top perspective view of a system is provided for a metal sheet screw position template according to a preferred embodiment of the invention. The top side of a substantially rectangular template 100 is illustrated, comprising a handle 10 on one distal end, a vertical alignment hole 20 on the second distal end, three divots 30 on the bottom side designed to receive three metal sheet ribs, a first set of horizontal alignment holes 40 to indicate four proper horizontal screw positions, and a second set of horizontal alignment holes 50 to indicate three alternate horizontal screw positions.

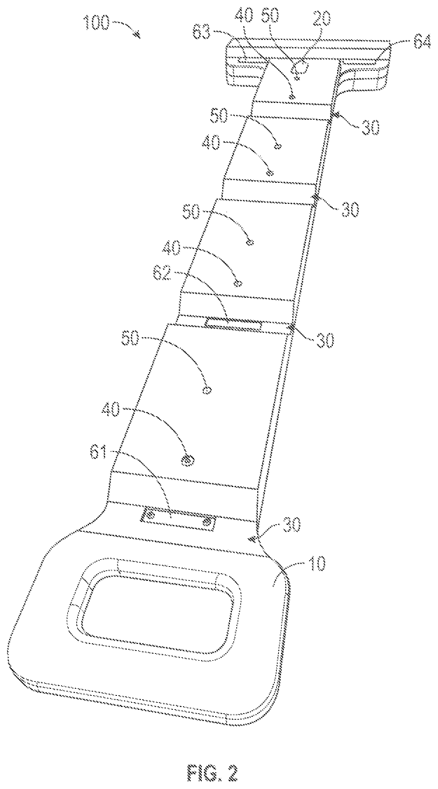

Referring now to FIG. 2, a bottom perspective view of the same metal sheet screw position template is provided according to a preferred embodiment of the invention. Template 100 is illustrated, comprising a handle 10 on one distal end and a vertical alignment hole 20 on the second distal end. Here, however, one can better see that a preferred embodiment includes four divots 30, which were not visible from the angle of FIG. 1, these designed to receive metal sheet ribs. Divots 30 are provided to allow template 100 to sit in place on four exactly spaced ribs projecting from a standard metal ribbed sheet, such as a roofing panel, as discussed more fully below.

One can also see the first set of horizontal alignment holes 40 to indicate four proper horizontal screw positions, and a second set of horizontal alignment holes 50 to indicate four different horizontal screw positions, where only 3 were visible in the angle of FIG. 1. In a preferred embodiment, two sets of horizontal alignment holes are provided because a typical metal sheet is generally installed as either a roofing panel or a siding panel, such as a carport panel. Installers have found that the screws should be placed in different locations for these two different applications. As such, horizontal alignment holes 40 indicate the proper screw locations for a metal roofing sheet, whereas horizontal alignment holes 50 indicate the proper screw locations for a metal siding sheet.

Also visible on the bottom are four magnets, 61, 62, 63, and 64, for firmly attaching template 100 to a standard metal sheet for use. These magnets are not positioned symmetrically with respect to template 100. Note that two are placed in divots 30 on one end of template 100, while missing from the remaining two divots 30. The last two magnets 63 and 64 are positioned on the distal end near vertical alignment bole 20 to more firmly attach that end for initially placing vertical alignment hole 20 on the correct location directly over the starter hole mark in the metal sheet. Testing of the invention has revealed that more than 4 magnets of the size and type illustrated hold too tightly, while less than 4 magnets of this size and type do not hold tightly enough.

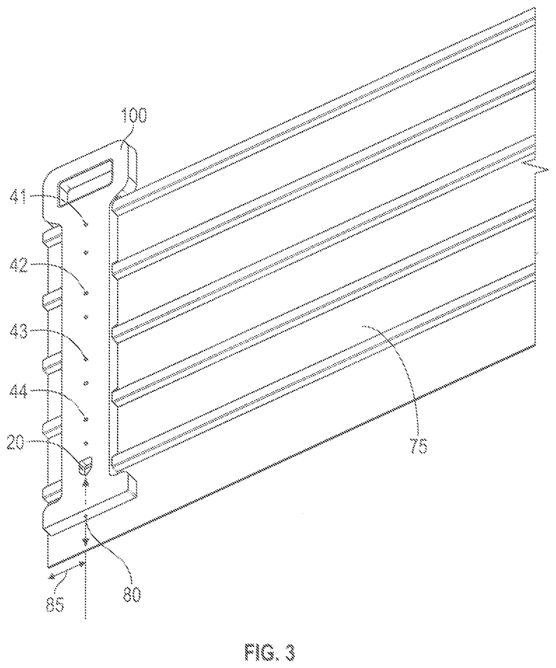

In normal use of the same preferred embodiment of FIGS. 1 and 2, now illustrated in FIG. 3, vertical alignment hole 20 is positioned directly over the starter hole mark 80 on a standard metal roofing sheet 75. Note that starter hole mark 80 is not directly visible in FIG. 3 because it is located under template 100. The roofer measures the overhang distance 85 and then marks that distance as the starter hole mark directly on the first rib of roofing sheet 75. Template 100 is then placed down onto roofing sheet 75 and the correct vertical alignment is determined by viewing the starter hole location through the vertical alignment hole 20 as shown. Once in place, the four divots 30 shown in FIG. 2 align template 100 in the correct horizontal position to locate the remaining screw holes.

Magnets 61, 62, 63, and 64 as shown in FIG. 2 hold template 100 in place once the correct vertical and horizontal position is achieved. Now the roofing installer can simply drill four screw holes directly through horizontal alignment holes 41, 42, 43, and 44 for proper screw placement.

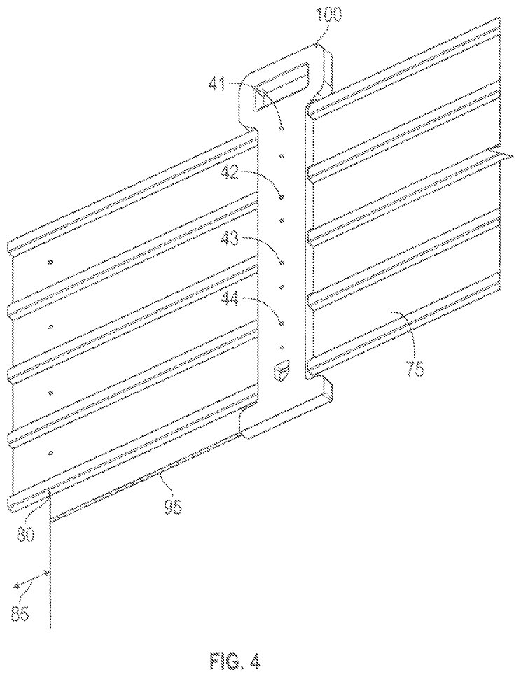

Once a first set of screws are installed horizontal alignment holes 41, 42, 43, and 44, as shown in FIG. 4, in a preferred embodiment template 100 is moved three feet upward vertically and the same process is repeated. Note that the starter hole location 80, which was not visible in FIG. 3 because it was under template 100, is now visible in FIG. 4. To assist in moving template 100 three feet upwards, internal measurement tape 95 is provided to quickly determine the correct three-feet measurement at each step. In one embodiment, measurement tape 95 may be configured internal to template 100 as shown in FIG. 4, while in other embodiments tape 95 may be configured on the exterior of template 100. In either embodiment, tape 95 adds to the speed with which a roofer may quickly position the template for continuous and symmetrical screw location.

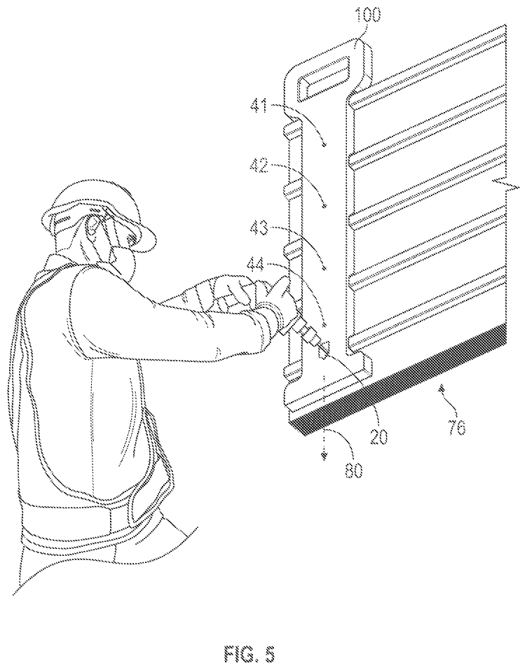

In another embodiment of the invention, the method of using template 100 may provide even further savings in time for installation of a metal roof. As shown in FIG. 5, the invention may be referred to as a stack and drill because the invention provides a method for simply drilling all metal sheets in advance of placement on a roof. In other words, the roofer can use template 100 on an entire stack of metal sheets while they are still on the ground to drill all holes as needed before placing each sheet on the roof.

In this method, a roofer places all the metal sheets into alignment once delivered to a job site. This can be done on the ground, on saw horses, etc. As shown in FIG. 5, the stack of metal sheets 76 is aligned on the ground at the job site. The roofer then measures the specific overhang of the roof to determine the location of starter hole mark 80. Vertical alignment hole 20 is then positioned directly over the starter hole mark 80 on the top of the stack of metal sheets 76. Template 100 is then placed down onto metal sheet stack 76 and the correct vertical alignment is determined by viewing the starter hole mark 80 through the vertical alignment hole 20 as shown. Once in place, the four divots 30 (shown in FIG. 2) align template 100 in the correct horizontal position so that all screw boles may be drilled through horizontal alignment holes 41, 42, 43, and 44.

As was shown in FIG. 4, in a preferred embodiment the roofer may then move template 100 three feet vertically to locate the next set of screw holes. Also as was shown in FIG. 4, measurement tape 95 may be used to speed the process. In this manner, all the metal sheets for an entire side of a roof, and in some cases both sides, can be predrilled before the metal sheets are placed on the roof. In such a case, the roofer can simply install all screws quickly in the predrilled boles to properly fasten the roof in up to half the time normally required for the same metal roof.

Most buildings differ in size, so the process of FIG. 5 must be performed on site for each building. If the building is a specific copy, however, such as many standard metal buildings, the process illustrated in FIG. 5 can be done at the factory, saving even more time.

The invention has been described with reference to the preferred embodiments without limit thereto. Additional embodiments and improvements may be realized which are not specifically set forth herein but which are within the scope of the invention as more specifically set forth in the claims appended hereto.

1. A metal sheet screw position template, comprising:
a horizontal alignment hole to indicate a proper horizontal screw position;
a vertical alignment hole to indicate a proper vertical screw position; and
a divot designed to receive a metal sheet rib.

2. The metal sheet screw position template of claim 1 further comprising a magnet for firmly attaching a metal sheet to said metal sheet screw position template.

3. The metal sheet screw position template of claim 1 further comprising a handle for carrying said metal sheet screw position template.

4. The metal sheet screw position template of claim 1 further comprising a measurement tape extending perpendicularly from said metal sheet screw position template to indicate a next placement of said metal sheet screw position template.

5. A method of using a metal sheet screw position template, comprising the steps of:
providing a metal sheet for installation upon a structure;
measuring an overhang on the roof of said structure;
marking the distance of said overhang on said metal sheet;
placing a metal sheet screw position template on said metal sheet, said metal sheet screw position template comprising:
a horizontal alignment hole to indicate a proper horizontal screw position; and
a vertical alignment hole to indicate a proper vertical screw position;
aligning said vertical alignment hole with said distance of said overhang;
marking the location of at least one said proper horizontal screw position; and
drilling a hole in said metal sheet at the location of said at least one said proper horizontal screw position.

6. The method of claim 5, wherein said metal sheet screw position template further comprises a divot designed to receive a metal sheet rib.

7. The method of claim 5, wherein said metal sheet screw position template further comprises a magnet for firmly attaching to said metal sheet.

8. The method of claim 5, wherein said metal sheet screw position template further comprises a handle for carrying.

9. The method of claim 5, wherein said metal sheet screw position template further comprises a measurement tape extending perpendicularly therefrom.

10. A method of using a metal sheet screw position template, comprising the steps of:
providing a stack of metal sheets for installation upon a structure;
measuring an overhang on the roof of said structure;
marking the distance of said overhang on a first metal sheet;
placing a metal sheet screw position template on said first metal sheet, said metal sheet screw position template comprising:
a horizontal alignment hole to indicate a proper horizontal screw position; and
a vertical alignment hole to indicate a proper vertical screw position;
aligning said vertical alignment hole with said distance of said overhang;
marking the location of at least one said proper horizontal screw position; and
drilling a hole in two or more metal sheets of said stack of metal sheets at the location of said at least one said proper horizontal screw position.

11. The method of claim 10, wherein said metal sheet screw position template further comprises a divot designed to receive a metal sheet rib.

12. The method of claim 10, wherein said metal sheet screw position template further comprises a magnet for firmly attaching to said metal sheet.

13. The method of claim 10, wherein said metal sheet screw position template further comprises a handle for carrying.

14. The method of claim 10, wherein said metal sheet screw position template further comprises a measurement tape extending perpendicularly therefrom.
